(19) United States
(12) Patent Application Publication
(10) Pub. No.: US 2021/0099304 A1
(43) Pub. Date: Apr. 1, 2021

(54) COMPOSITE IDENTITY AUTHENTICATION METHOD AND COMPOSITE IDENTITY AUTHENTICATION SYSTEM USING SAME

(71) Applicant: Dejian KONG, Foshan (CN)

(72) Inventor: Dejian KONG, Foshan (CN)

(21) Appl. No.: 17/072,767

(22) Filed: Oct. 16, 2020

Related U.S. Application Data
(63) Continuation of application No. PCT/CN2018/122556, filed on Dec. 21, 2018.

(30) Foreign Application Priority Data
Apr. 19, 2018 (CN) 201810354021.1

(51) Int. Cl. H04L 9/32; H04L 9/08

(52) U.S. Cl. CPC H04L 9/3231; H04L 2209/38; H04L 9/085; H04L 9/0847

(57) ABSTRACT

Provided are a composite identity authentication method and a composite identity authentication system using the same. The composite identity authentication system is applied to a blockchain network and includes an authenticator and terminals. The composite identity authentication method is based on the blockchain network, and can ensure both the security and the generality. The multiple authentication mechanisms can be used flexibly according to different security levels, and flexible terminal authorization methods are provided to make management more convenient. The composite identity authentication system is applied to the blockchain network, and the terminals connected to the blockchain network can call data from the blockchain, which avoids repeated data entry in different terminals. Different authentication contents can be configured in terminals of different security levels, rendering the authentication of the system more flexible.

### CROSS-REFERENCE TO RELATED APPLICATIONS

This application is a continuation of International Application No. PCT/CN2018/122556, filed on Dec. 21, 2018, which claims the benefit of priority from Chinese Patent Application No. 201810354021.1, filed on Apr. 19, 2018. The content of the aforementioned applications, including any intervening amendments thereto, is incorporated herein by reference.

### TECHNICAL FIELD

The present application relates to internet information processing, and more particularly to a composite identity authentication method and a composite identity authentication system using the same.

### BACKGROUND

There are various identity authentication methods in the prior art, such as authentication of passwords (withdrawal passwords, login passwords, etc.), authentication of biological information (fingerprints, iris, sound waves, vein information, etc.), and authentication of physical information (keys, smart cards, Near Field Communication (NFC), etc.). However, the authentication of password has low security performance since passwords are easy to be obtained by others through such as recording and monitoring. The authentication of biological information is easy to be cracked by simulation. Furthermore, biological information is mainly saved by single departments or single terminals, so it is required to be repeatedly inputted when applied to different terminals, which is not convenient to use. The physical information is easy to be copied or stolen, or corresponding authentication tools may be lost. Therefore, the existing identity authentication methods still have certain technical defects and risks.

Due to the development of internet and the maturity of blockchain, multiple nodes are involved for the maintenance of a database, which ensures the safety and reliability. The decentralization, transparency, and tamper resistance of the blockchain make it a credible platform for original data storage.

Therefore, there is a need to provide a composite identity authentication method and a composite identity authentication system based on the blockchain, so as to make the identity authentication of convenient and safe.

### SUMMARY

In view of the problems in the prior art, the present disclosure aims to provide a composite identity authentication method and a composite identity authentication system using the same.

Provided is a composite identity authentication method, comprising:

1) obtaining original information, wherein the original information comprises physical information, biological information or mixed information for identifying an identity of a user; and converting and encrypting the original information to generate an encrypted authentication information corresponding to the original information;

2) sending the encrypted authentication information to a blockchain network, and storing the encrypted authentication information in the blockchain network;

3) linking a plurality of terminals with the blockchain network to synchronize the encrypted authentication information; and selecting corresponding encrypted authentication information as an authentication condition of each of the terminals according to a set security level;

4) obtaining verification information, and converting and encrypting the verification information to generate encrypted verification information; and

5) comparing the encrypted verification information with the encrypted authentication information for the authentication based on the authentication condition of the terminal; and determining that the authentication is passed when the encrypted verification information is consistent with the encrypted authentication information.

The principle of the composite identity authentication method is described as follows.

The user converts the physical information for identifying the identity of the user into corresponding encrypted physical authentication information, the biological information into corresponding encrypted biological authentication information, and the mixed information into corresponding encrypted mixed authentication information, respectively. The encrypted authentication information are sent into and stored in a blockchain network to be synchronized by the terminals. Each of the terminals sets different combinations of the encrypted authentication information according to the authentication conditions based on the security levels. The users can pass the authentication of different terminals through the original information, so as to make the identity authentication more flexible.

The encrypted authentication information and the encrypted verification information are hash values generated by the hash algorithm, so that the encrypted information can be used in the blockchain network.

In some embodiments, the authentication condition is generated by the encrypted authentication information that is converted and encrypted from single original information, or is generated by the encrypted authentication information that is converted and encrypted from composite original information through logic and/or computing, so that the authentication method can be applied in the terminals of different security levels.

In some embodiments, each of the terminals is provided with identification information which is independent; in the step 1, the encrypted authentication information is bound with the identification information; in the step 2, the identification information is sent and stored in the blockchain network together with the encrypted authentication information; and in the step 3, each of the terminals searches for the encrypted authentication information bound with the identification information in the blockchain network based on the identification information of each of the terminals.

The encrypted authentication information in the blockchain network is bound with the identification information, and each of the terminals can quickly screen out the bound encrypted authentication information in the blockchain network according to its independent identification information, and synchronize the encrypted authentication information, which can effectively improve the speed of authentication.

In some embodiments, a request is sent to the blockchain network through the terminal to mark the encrypted authentication information, so as to add an authorized identity of the user; another request is sent to the blockchain network through the terminal to reversely mark the encrypted authentication information, so as to delete the authorized identity of the user. The terminal adds or deletes authorized identities by initiating transactions on the blockchain network, which can effectively improve authentication efficiency and facilitate management applications.

In some embodiments, the mixed information is composed of a combination of specific physical information and specific biological information; the specific physical information and the specific biological information are corresponding original information selected and determined by user's subjective wishes based on actual needs. Specifically, for example, the specific physical information is the shape information of a physical key or chip information recorded on a digital key; the specific biological information is fingerprint information of middle finger of user's left hand or iris information of user's right eye, etc. The specific physical information combines with the specific biological information to generate the mixed information, which makes the authentication of the terminals more flexible.

The present disclosure further provides a composite identity authentication system. In the composite identity authentication system, the authentication is performed by the composite identity authentication method, which renders the authentication of the terminals more flexible.

In some embodiments, the physical information or the biological information is adopted in the terminals for the authentication, which can be used for the basic-level authentication.

In some embodiments, the physical information and the biological information are adopted in the terminals for the authentication, which can be used for the medium-level authentication.

In some embodiments, the mixed information is adopted in the terminals for the authentication, which can be used for the high-level authentication.

In some embodiments, the physical information, the biological information and the mixed information are adopted for the authentication, which can be further used for the high-level authentication.

In some embodiments, the authentication encryption information is stored locally in the terminals, which further improves the speed of the authentication.

Compared to the prior art, the present invention has the following beneficial effects.

1. The composite identity authentication method is based on the blockchain network, which can ensures both the security and generality. The users can pass the authentication of different terminals through the original information, which makes the identity authentication more flexible.

2. The encrypted authentication information in the blockchain network is marked or reversely marked according to requests of the terminals, so as to add or delete the authorized identities by initiating transactions, which makes the user management more convenient.

3. The composite identity authentication system is applied to a blockchain network, and any terminal connected to the blockchain network can synchronize data from the blockchain, which avoids repeated data entry in different terminals.

4. The terminals of the composite identity authentication system have multiple authentication mechanisms and can be set to different security levels according to different application conditions, which ensures the security of the identity authentication system.

### DETAILED DESCRIPTION OF EMBODIMENTS

This embodiment illustrates a composite identity authentication system and a composite identity authentication method which is applied for the identity authentication system. The composite identity authentication system is provided with a plurality of terminals. When a terminal needs to add original information of a user, original physical information and biological information of the user need to be input into the system, and the system saves the these information. If necessary (for high level authentication), the user combines specific physical information and specific biological information in the system to generate mixed information, and then the system saves the three kinds of original information.

The system converts the three kinds of original information, through a hash algorithm, to three hash values which are applied as encrypted authentication information of the user. The hash values are bound with an identification of the terminal respectively, and are sent to a blockchain network as information to be confirmed.

The blockchain network generates a block, and the information to be confirmed is confirmed and stored in the block. The block is synchronized in all terminals connected to the blockchain network, and the information in the block is verified. At this time, the encrypted authentication information of the user recorded in the block of the blockchain network can be called by each terminal at any time to prepare for authentication in the terminals.

During authentication, the terminal searches the block bound to the encrypted authentication information in the blockchain network according to independent identification information of the terminal, and then obtains the encrypted authentication information according to a security level of the terminal, and selects the encrypted authentication information corresponding to the security level of the terminal as an authentication condition.

The terminal converts input verification information to encrypted verification information through a hash algorithm. The input encrypted verification information is compared with the encrypted authentication information set according to the authentication condition of the terminal. When the input encrypted verification information is consistent with the encrypted authentication information, the terminal determines that the authentication is passed.

Based on the composite identity authentication system of the present disclosure, the terminals can set identity authentication conditions of different security levels in different occasions.

A. For general applications, such as burglar-proof doors at home and entrance guard in companies, authentication of the terminal is set to a basic level, and the terminal synchronizes the physical authentication information and the biological authentication information of the user through the blockchain network. When the user requests for authentication, physical information or biological information should be input and converted for the authentication. This kind of authentication is simple and efficient.

B. For some places where the authentication needs to be performed by one or more people, such as different laboratories in the research institute, important data rooms in companies, the authentication of the terminal is set to a medium level, and the terminal synchronizes the physical authentication information and the biological authentication information through the blockchain network. When the user requests for the authentication, both of the physical information and the biological information should be input and converted for the medium-level authentication.

C. For places where strict identity authentication is needed, such as a safe deposit box and login of personal online banking, authentication of the terminal is set to a high level. The user inputs the physical information and the biological information through the system, and then selects specific physical information and specific biological information (such as chip information recorded on a digital key and fingerprint information of the middle finger of user's left) in the system to generate mixed information. The system further converts the mixed information to mixed authentication information through the hash algorithm, and the mixed authentication information is stored in the blockchain network. The high-level authentication terminal synchronizes the physical authentication information, the biological authentication information and the mixed authentication information of the user through the blockchain network. When the user requests for the authentication, specific mixed information or all of the physical information, the biological information and the mixed information are input and converted for the high-level authentication.

The present disclosure will be further described below with reference to the accompanying embodiment, from which the technical solution, object and the beneficial effects will be clearer.

The user registers original identity information in the system, and the system converts and encrypts the original identity information into the encrypted authentication information, and then the encrypted authentication information is stored in the blockchain network. A door lock using the system is arranged on a door of home, and the authentication of the door lock is set to the basic level. The door lock writes an identification of the door lock to the encrypted authentication information of the user in the blockchain network. When the user inputs the physical information and the biological information into the door lock, the door lock quickly searches and obtains the encrypted authentication information of the user in the blockchain network according to the identification of the door lock. Input information is converted for the authentication, and the user unlocks the door lock after the authentication is passed.

When the user goes out to the company, and an entrance guard of the system is applied in the company, the user can index the encrypted authentication information registered in the blockchain network, and send a request to the blockchain network through the entrance guard to bind an identification of the entrance guard with the encrypted authentication information registered in the blockchain network, and then the encrypted authentication information of the user is marked, so that the user can obtain the authorized identity of the entrance guard of the company. The authentication of the entrance guard is set to the medium level. When the user inputs the physical information and the biological information into the door lock, the entrance guard quickly searches and obtains the encrypted authentication information of the user in the blockchain network according to the identification of the entrance guard. The input information is converted for authentication, and the user unlocks the entrance guard after the authentication is passed.

In some embodiments, the encrypted authentication information of the user in the blockchain network is downloaded and stored locally in the entrance guard after being indexed by the user, and the local authentication information is used for comparison, which can effectively improve the authentication speed of the system.

When the user resigns from the company, the manager can delete the encrypted authentication information stored in the entrance guard of the company, and send a request to the blockchain network through the entrance guard to reversely mark the encrypted authentication information of the user in the blockchain network, so as to delete the authorized identity of the user in the entrance guard of the company. That is, when the user enters the physical information and the biological information to the entrance guard after resigned from the company, the entrance guard cannot obtain the encrypted authentication information of the user in the blockchain network due to the reversely marked encrypted authentication information, so that the user cannot access the entrance guard of the company.

When the user uses the safe deposit box with the composite identity authentication system, the user can index the encrypted authentication information registered in the blockchain network, and send a request to the blockchain network through the safe deposit box to bind an identification of the safe deposit box with the encrypted authentication information registered in the blockchain network. The authentication of the safe deposit box is set to the high level. When the user inputs the mixed information of the user or a combination of the physical information, the biological information and the mixed of the user into the safe deposit box, the safe deposit box quickly searches and obtains the encrypted authentication information of the user in the blockchain network according to the identification of the safe deposit box. The input information is converted for authentication, and the user unlocks the safe deposit box after the authentication is passed.

The above are only the preferred embodiments of the present disclosure. Any modifications made by those skilled in the art without departing from the spirit of the present disclosure shall fall within the scope of the present disclosure.

What is claimed is:

1. A composite identity authentication method, comprising:
1) obtaining original information, wherein the original information comprises physical information, biological information or mixed information for identifying an identity of a user; and converting and encrypting the original information to generate an encrypted authentication information corresponding to the original information;
2) sending the encrypted authentication information to a blockchain network, and storing the encrypted authentication information in the blockchain network;
3) linking a plurality of terminals with the blockchain network to synchronize the encrypted authentication information; and selecting corresponding encrypted authentication information as an authentication condition of each of the terminals according to a set security level;
4) obtaining verification information, and converting and encrypting the verification information to generate encrypted verification information; and
5) comparing the encrypted verification information with the encrypted authentication information for the authentication based on the authentication condition of the terminal; and determining that the authentication is passed when the encrypted verification information is consistent with the encrypted authentication information.

2. The composite identity authentication method of claim 1, wherein the authentication condition is generated by the encrypted authentication information that is converted and encrypted from single original information, or is generated by the encrypted authentication information that is converted and encrypted from composite original information through logic and/or computing.

3. The composite identity authentication method of claim 1, wherein each of the terminals is provided with identification information which is independent; in the step 1, the encrypted authentication information is bound with the identification information; in the step 2, the identification information is sent and stored in the blockchain network together with the encrypted authentication information; and in the step 3, each of the terminals searches for the encrypted authentication information bound with the identification information in the blockchain network based on the identification information of each of the terminals.

4. The composite identity authentication method of claim 1, wherein a request is sent to the blockchain network through the terminal to mark the encrypted authentication information, so as to add an authorized identity of the user; another request is sent to the blockchain network through the terminal to reversely mark the encrypted authentication information, so as to delete the authorized identity of the user.

5. The composite identity authentication method of claim 1, wherein the mixed information is composed of specific physical information and specific biological information.

6. A composite identity authentication system in which the authentication is performed by using the composite identity authentication method of claim 5.

7. The composite identity authentication system of claim 6, wherein the physical information and/or the biological information are adopted for the authentication in the terminals.

8. The composite identity authentication system of claim 6, wherein the mixed information is adopted for the authentication in the terminals.

9. The composite identity authentication system of claim 6, wherein the physical information, the biological information and the mixed information are adopted for the authentication in the terminals.

10. The composite identity authentication system of claim 6, wherein the terminal locally stores the encrypted authentication information.
